(19) United States
(12) Patent Application Publication
(10) Pub. No.: US 2011/0167258 A1
(43) Pub. Date: Jul. 7, 2011

(54) Efficient Secure Cloud-Based Processing of Certificate Status Information

(75) Inventor: Norman Schibuk, Merrick, NY (US)

(73) Assignee: SURIDX, INC., Wellesley, MA (US)

(21) Appl. No.: 12/981,908

(22) Filed: Dec. 30, 2010

Related U.S. Application Data
(60) Provisional application No. 61/291,018, filed on Dec. 30, 2009.

(51) Int. Cl. H04L 9/00

(52) U.S. Cl. 713/156

(57) ABSTRACT

A cloud-based system having a secure database of certificate information and associated methods are provided. The system and methods may be used to supplement or replace traditional OCSP processing systems. Responses to OCSP requests are digitally signed and cached in a cloud database server remote from the requester. Other servers in the cloud may access the cached OCSP responses from the database server, rather than the originating certificate authority. Thus, the work traditionally done by the certificate authority is moved to the cloud, which eliminates a single point of failure and improves the resources available to perform transactional processing.

### CROSS-REFERENCE TO RELATED APPLICATION

This application claims the benefit of United States Provisional Patent Application No. 61/291,018 filed on Dec. 30, 2009, which is incorporated herein by reference in its entirety.

### TECHNICAL FIELD

The present invention relates to public key infrastructure, and more particularly to processing of status information relating to digital certificates.

### BACKGROUND ART

A public key infrastructure (PM) provides a model through which electronic devices may authenticate themselves to each other and exchange encrypted messages. PM is described in industry standards, for example International Telecommunication Union, Information technology-Open Systems Interconnection-The Directory: Public-key and attribute certificate frameworks, hereby incorporated by reference. This standard is known as “X.509”, and may be found on the Internet at http://www.itu.int/rec/T-REC-X.509/en. A PKI allows an individual to validate the public data of another individual, typically a public encryption key. The public key is distributed, via a computer network, in a certificate, and a cryptographic algorithm may be applied to ensure its accuracy. Certificates are described in Internet Engineering Task Force (IETF), Request for Comments (RFC) 3280: Internet X509 Public Key Infrastructure Certificate and Certificate Revocation List (CRL) Profile, hereby incorporated by reference, and which may be found at http://tools.ietforg/html/rfc3280. Several companies, such as RSA Security, offer public key infrastructure software and services. Using a PM, messages can be sent from one device to another without possibility of undetected alteration, so PM systems are important in such diverse applications as electronic commerce, physical access systems, and secure communications.

However, present PM systems suffer from a number of drawbacks. First, an organization (such as the Department of Defense) or business enterprise (such as IBM Corporation) may have thousands of locations and hundreds of thousands of employees. Quickly responding to authentication requests generally requires duplicating and distributing data to many servers and locations. The process of distributing data, and the resultant data availability at a number of sites, introduces security attack vectors. Second, as a practical matter this data model requires authenticating applications to be connected to a data network, potentially incurring high costs to provide connectivity. Third, enterprises may wish to communicate with each other. Trust may be developed differently within each enterprise, and one internal trust model may be different from the other. A party in one enterprise verifying a trust relationship within the other enterprise must use a foreign trust model, a potentially complex undertaking. Given certain PKI constraints, such as limitations on the length of a trust chain, it may be impossible to verify trust cross organizations under certain conditions. Also, each enterprise may need to query many different servers to obtain complete trust information, resulting in slow response times and high network traffic.

These drawbacks may be summarized by noting that the PKI deployment model currently in use does not efficiently serve the relationships and physical geometries of the participating parties to large numbers of authentication transactions. Current systems assume that an authenticating party can be in any place any time, requiring large amounts of bandwidth and large numbers of servers to move authentication data and validate it. This architecture does not scale, even in reasonably small use cases.

More particularly, there has been developed an Online Certificate Status Protocol (OCSP), specified in RFC 2560 of the IETF, (available at http://tools.ietf.org/html/rfc2560), which is computationally intensive and requires a great deal of data movement. The OCSP specifies a message, digitally signed, typically by the Certificate Authority (CA), and which contains the then current status of the certificate to which it pertains. Status information in the message is constructed from the CRL (Certificate Revocation List), which is produced on a regular schedule by the CA. The CRL contains the list of all certificates that have been revoked prior to their expiration date. The list can be very long (in the case of the US Department of Defense, the CRL lists more than 5 million revocations and is growing). For each revocation, an OCSP message must be produced. When OCSP is implemented in a distributed system, there must also be produced a corresponding series of good certificate responses. In the case of the Department of Defense, the OCSP involves, in the aggregate, more than 20 million digitally signed messages.

In its native mode, the OCSP has disadvantages including the risk of replay attack (in which a valid data message is maliciously repeated or delayed), denial of service attack (in which a computer resource is maliciously flooded with messages to prevent normal use of the resource), barriers to effectuating certificate revocation in real time (owing to the housekeeping requirements of cyclically updating the CRL and generating corresponding OCSP messages for each certificate on the CRL), and barriers to making implementation of the protocol more secure (because use of a nonce or similar device would further encumber a protocol that is inherently computationally intensive. These disadvantages limit the utility of OCSP.

### SUMMARY OF THE INVENTION

In a first embodiment of the invention there is provided a secure computer-implemented method of processing digital certificate status information. The method of this embodiment includes receiving over a network, at a status server that is coupled to a data store, from a terminal of a relying party, a request message seeking certificate status information, the request message including data associated with the certificate and a nonce, and the request message encrypted by the terminal using a public key of the status server. In this embodiment, the data store has stored a last status message, received from a certificate authority server, concerning the certificate, such status message stored in a location address determinable by an algorithm applied to data of the certificate. The method additionally includes decrypting the request message at the status sever using a private key of the status server, and, at the status server, applying the algorithm to the certificate data in the decrypted request message to identify the location address of the data store for status information pertaining to the certificate and causing retrieval of the stored last status message. The method further includes, at the status server, updating the retrieved status message with a current time-stamp, expanding the message to include the nonce from the decrypted request message, encrypting the expended status message with a public key of the relying party, and sending the encrypted expanded status message to the terminal of the relying party. In this way, the terminal of the relying party on receipt of the expanded status message can decrypt the expanded status message and determine, based on appearance of the nonce in the decrypted expanded status message, the reliability of the status information therein. In a further related embodiment, the algorithm is a hash.

### BRIEF DESCRIPTION OF THE DRAWINGS

The foregoing features of the invention will be more readily understood by reference to the following detailed description, taken with reference to the accompanying drawings, in which:

FIG. 1 is a block diagram of processes used to establish a cloud-based system having a secure database of certificate information in accordance with an embodiment of the present convention; and

FIG. 2 is a block diagram of processes employed by the cloud-based system in handling a request for certificate information.

### DETAILED DESCRIPTION OF SPECIFIC EMBODIMENTS

Compared to traditional OCSP, various embodiments of the new system have the following advantages:

1. Great reduction in the amount of data transmitted in supporting OCSP messages (potentially one-millionth as much);

2. Ability to handle real-time certificate revocations and elimination of delay required in the prior art for updating according to the next CRL update cycle;

3. Ability to provide millions of responses per second;

4. State-of-the-art cloud redundancy and backup;

5. Low cost and system capacity that can accommodate business rules requiring an OCSP refresh at any time as well as single use configuration for mission critical and high security sites; and

6. Creation of digitally signed messages that are trusted.

Embodiments of the present convention achieved in these characteristics by establishing a cloud-based system (that is, a system in which data and services are established on a network, such as the Internet, rather than locally) that is configured to operate as a secure extension of the certificate authority itself. The embodiments described herein provide a mechanism that is an alternative to mechanisms described in published PCT application WO 2009/070430, for my invention of Apparatus and Methods Providing Scalable, Dynamic, Individualized Credential Services Using Mobile Telephones. This application is incorporated herein by reference in its entirety as “the Mobile Credential Application”.

Data transmissions from the cloud to a user within various embodiments may use techniques described in U.S. provisional application 61/177,539, for my invention Systems and Methods for Facilitating Secure Communication Using Public Key Encryption. Commands that require strong identity, sent from a user to the cloud, may be transmitted using techniques described in U.S. provisional application 61/228,847, for my invention Secure Transactions Using Light Weight Credentials. These two provisional applications are incorporated herein by reference in their entireties.

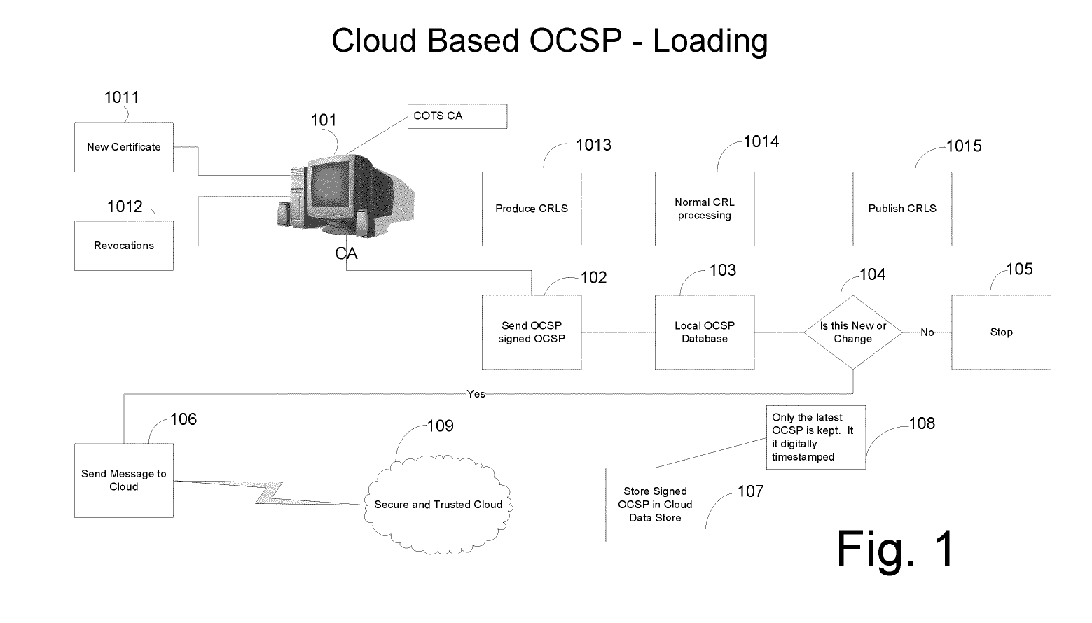

FIG. 1 is a block diagram of processes used to establish a cloud-based system having a secure database of certificate information in accordance with an embodiment of the present convention. The certificate authority 101 is generally implemented as a conventional off-the-shelf (COTS) system. The certificate authority 101 in process 1011 receives new certificate information and in process 1012 receives certificate revocation information. In its normal operation in accordance with the prior art, the certificate authority may optionally continue with prior art processes such as producing certificate revocation lists (CRLs) in process 1013, performing CRL processing in process 1014, and publishing CRLs in process 1015.

As an alternative or supplement to traditional CRL processing, an additional series of processes is carried out to populate a cloud-based system certificate database with current certificate information. This series of processes may usefully be implemented in the certificate authority but alternatively may be carried out by a separate computer system in communication with the certificate authority. In process 102 there is issued from the certificate authority a digitally signed OCSP message, which in process 103 is stored in a local OCSP database. In process 104 a logical determination is made whether the OCSP message is a new or changed message. If the OCSP message is deemed not to be new or changed, then in process 105, processing of the OCSP message is stopped. If the OCSP message is deemed to be new or changed, then in process 106 the message is sent to the cloud-based system 109. Because the OCSP message is itself digitally signed, it does not matter that the network (such as the Internet) over which the OCSP message is sent is insecure, and the OCSP message need not be encrypted. As part of normal processing in sending the OCSP message, there is included a hash of the message, and the cloud server 109 uses the hash in order to validate the message. The cloud server acknowledges receipt of the message. Upon validation of the message, in process 107, the cloud server stores and indexes the digitally signed message in a secure data store.

The storage location for the digitally signed message in the secure data store is determined based on content of the message, and in particular is based on the certificate to which the message relates. An algorithm, typically implemented here by a hash, is performed on the certificate data to determine the storage location. In this fashion, given the certificate data, one can readily find the storage location where status information pertaining to the certificate can be accessed. In process 108, the digitally signed OCSP message is time stamped at the time of storage and is stored on a last in, first out (LIFO) basis; in fact it is strictly necessary only to store the latest message.

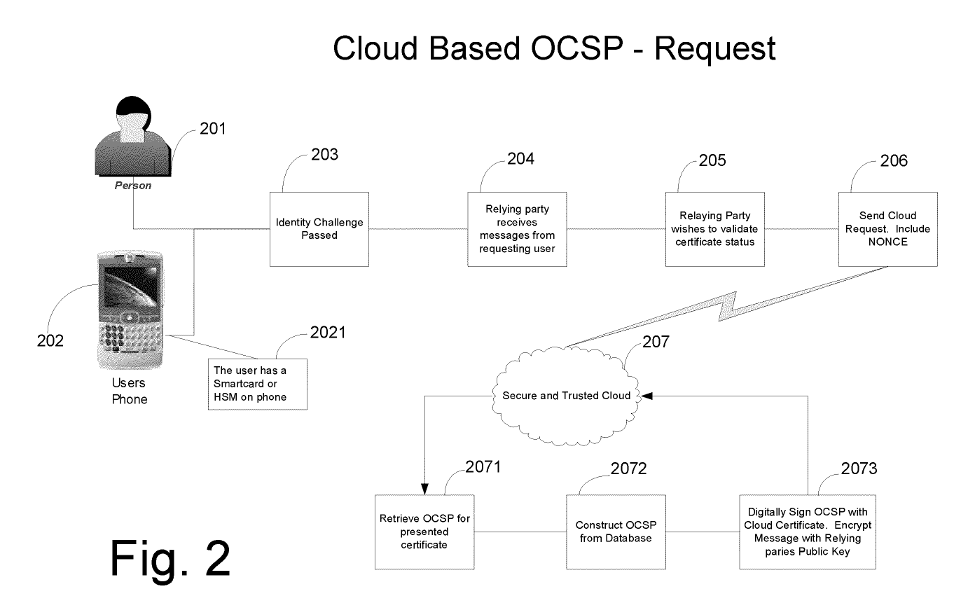

FIG. 2 is a block diagram of processes employed by the server in a cloud-based system in handling a request for certificate information. The server of a relying party in process 204 may receive a request from a user for engaging in a “transaction” (as that term is used in the Mobile Credential Application). The user may be employing a smartcard or a smart phone 202 having a hardware security module in accordance with process 2021. Alternatively the user may simply be an individual. In either case, in process 203 an identity challenge for the user is presented, and in the case of the user as a natural person 201, the challenge may be met by presenting appropriate identification such as a driver's license. Alternatively, the user might authenticate himself to the smart phone 202 in a manner described in the Mobile Credential Application. Following the request in process 204 from the user to engage in a transaction, in process 205 the server of the relying party determines to validate the certificate status of the user. Thereafter in process 206, the server of the relying party generates a message requesting current certificate status information of the user; this request message includes a nonce (that is, a uniquely generated random number). The server of the relying party then encodes the request message with the public key of the server in the cloud system and sends the message to the cloud system 207.

On receipt of the request message, the cloud server decrypts it with its private key. In process 2071, the cloud server uses the certificate information in the request information in the algorithm (e.g., the aforementioned hash) to determine the storage address in the secure data store for status information pertaining to the certificate. It then causes retrieval from the determined storage address of the previously stored OCSP message pertaining to the certificate. Following retrieval of the OCSP message, the cloud server in process 2072 creates an updated OCSP message by updating the timestamp in the retrieved OCSP message to indicate the absence of any revocation between the time of storage of the OCSP message in the secure data store and the present time. In process 2073, the server constructs a response to the request message that includes (i) the updated OCSP message, digitally signed with the private key of the cloud-based system and (ii) the decrypted nonce. The response is itself encrypted with the public key of the server of the relying party and is then sent over a network (such as the Internet which may be insecure) to the server of the relying party, where the response may be decrypted with the private key of the relying party. The server of the relying party then tests for the presence of the same nonce that it generated with its original request message in order to validate the response.

An alternative to reconstructing the original OCSP message as described is to wrap it and include a new timestamp and nonce that is digitally signed and encrypted. While not standard OCSP, this does contain the OCSP signed by the certificate authority and cloud additions which will be signed by the cloud.

At any time, the certificate authority may issue a CRL, even if it is one entry long. This circumstance enables the OCSP to be updated in real-time and provides for real-time revocation processing. It can be seen from the foregoing that the revocation OCSP need be produced only once, and the valid OCSPs are generated only once from the certificate authority and need not be replicated or pre-signed. The relying party should be able to request a nonce to verify the sender and that the message is digitally signed.

It is clear from the architecture of this system that it can be expanded in numbers of ways. For example, because the cloud-based system is constructed as a secure extension of the certificate authority, one may implement the arrangement so that an authorized individual could cause revocation of a certificate directly in the cloud-based system and then cause a corresponding update of the certificate authority.

Embodiments described herein may be implemented using computer systems that include a processor controlled by instructions stored in a memory. The memory may be random access memory (RAM), read-only memory (ROM), flash memory or any other memory, or combination thereof, suitable for storing control software or other instructions and data. Some of the functions performed by embodiments herein have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks) as a computer program product having program code, information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

It will be understood by those of ordinary skill in the art that modifications to, and variations of, the illustrated embodiments herein may be made without departing from the inventive concepts disclosed herein. For example, although some aspects of the embodiments have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A secure computer-implemented method of processing digital certificate status information, the method comprising:
receiving over a network, at a status server that is coupled to a data store, from a terminal of a relying party, a request message seeking certificate status information, the request message including data associated with the certificate and a nonce, and the request message encrypted by the terminal using a public key of the status server;
wherein the data store has stored a last status message, received from a certificate authority server, concerning the certificate, such status message stored in a location address determinable by an algorithm applied to data of the certificate;
decrypting the request message at the status sever using a private key of the status server;
at the status server, applying the algorithm to the certificate data in the decrypted request message to identify the location address of the data store for status information pertaining to the certificate and causing retrieval of the stored last status message;
at the status server, updating the retrieved status message with a current time-stamp, expanding the message to include the nonce from the decrypted request message, encrypting the expended status message with a public key of the relying party, and sending the encrypted expanded status message to the terminal of the relying party, so that the terminal of the relying party on receipt of the expanded status message can decrypt the expanded status message and determine, based on appearance of the nonce in the decrypted expanded status message, the reliability of the status information therein.

2. A method according to claim 1, wherein the algorithm is a hash.
